(19) United States
(12) Patent Application Publication
(10) Pub. No.: US 2016/0292656 A1
(43) Pub. Date: Oct. 6, 2016

(54) Generating a Receipt in Point-of-Sale (POS) Systems

(71) Applicant: Toshiba Global Commerce Solutions Holdings Corporation, Tokyo (JP)

(72) Inventors: Dean Frederick Herring, Youngsville, NC (US); Brad M. Johnson, Raleigh, NC (US); Jeffrey Smith, Raleigh, NC (US); Adrian Rodriguez, Durham, NC (US)

(21) Appl. No.: 14/674,456

(22) Filed: Mar. 31, 2015

(51) Int. Cl. G06Q 20/20; G06Q 20/04; G06Q 20/32; G06Q 20/10; G06F 17/30

(52) U.S. Cl. CPC G06Q 20/20; G06Q 20/10; G06F 17/30525; G06Q 20/3221; G06Q 20/0453

(57) ABSTRACT

A Point-of-Sale (POS) terminal displays a Graphical User Interface (GUI) on one or more displays. While a customer transaction is taking place, the GUI is configured to allow a sales associate, or a customer, to enter annotation data. The annotation data, which may be free-form text, may include a command that specifies how the underlying details of the transaction are to be modified, and corresponding annotation data that specifies the changes to the content of the transaction details. Once the transaction details are modified, the POS terminal uses the modified details to generate a receipt.

### FIELD OF INVENTION

The present disclosure relates generally to Point-of-Sale (MPOS) systems, and more particularly, to a method and apparatus for generating a receipt for a customer transaction while the transaction is being performed.

### BACKGROUND

The retail Point of Sale (POS) terminal has evolved from a mechanical cash register to a sophisticated, networked terminal capable of rapidly identifying selected items for purchase (e.g., via optical scanning or RFID reading), tallying the order, accepting payment in a variety of forms, and generating a customer receipt. Many modern POS terminals have additional capabilities, such as transmitting or e-mailing an electronic version of the receipt to a customer.

Regardless of whether a receipt is printed or emailed, however, conventional receipts are generated to show the details of a transaction such as a product ID, a product description, quantity, and cost. In some cases, some devices will allow a store associate to add an annotation, which is then printed or overlaid on the transaction details of the receipt without changing the underlying transaction details.

### BRIEF DESCRIPTION OF THE DRAWINGS

FIG. 1 is a functional block diagram illustrating a Point-of-Sale (POS) system configured according to one embodiment of the present disclosure.

FIG. 2 is a block diagram illustrating the communication of data between a POS terminal and an application server according to one embodiment of the present disclosure.

FIGS. 3A-3B illustrates perspective views of some POS terminals configurable according to embodiments of the present disclosure.

FIG. 4 illustrates a Graphical User Interface (GUI) configured according to one embodiment of the present disclosure.

FIG. 5 is a flow diagram illustrating a method for generating a receipt in a POS system according to one embodiment of the present disclosure.

FIG. 6 is a flow chart illustrating a method for modifying the details of a customer transaction according to one embodiment of the present disclosure.

FIG. 7 is a flow chart illustrating a method for modifying the details of a customer transaction according to another embodiment of the present disclosure.

FIG. 8 is a flow diagram illustrating a method for generating a receipt in a POS system according to another embodiment of the present disclosure.

FIG. 9 is a functional block diagram illustrating some functional components of a POS terminal configured according to one embodiment of the present disclosure.

FIG. 10 is a logical block diagram illustrating a memory circuit for storing software modules executed by a POS terminal according to embodiments of the present disclosure.

FIG. 11 is a logical block diagram illustrating physical units within the processing circuitry of a POS terminal configured according to embodiments of the present disclosure.

### DETAILED DESCRIPTION

Embodiments of the present disclosure provide a method, a Point-of-Sale (POS) terminal, and a corresponding computer-readable storage medium for annotating a receipt associated with a customer transaction while the items associated with the customer transaction are being scanned. More particularly, the present disclosure modifies the underlying details of a customer transaction to include the annotations while items associated with the transaction are being scanned at the POS terminal. Additionally, in some embodiments, the underlying transaction details are modified in a manner indicated by the annotations. Once the transaction is complete, the modified transaction details are utilized to generate a receipt, which may be printed or emailed to the customer.

The annotations may be provided, for example, by a sales associate who is operating the POS terminal or by the customer, and are received by the POS terminal at one or more selectively activated, designated annotation areas of a Graphical User Interface (GUI). In operation, the POS terminal analyzes the annotations entered into the designated areas, and uses the information in the annotations to modify the underlying transaction details.

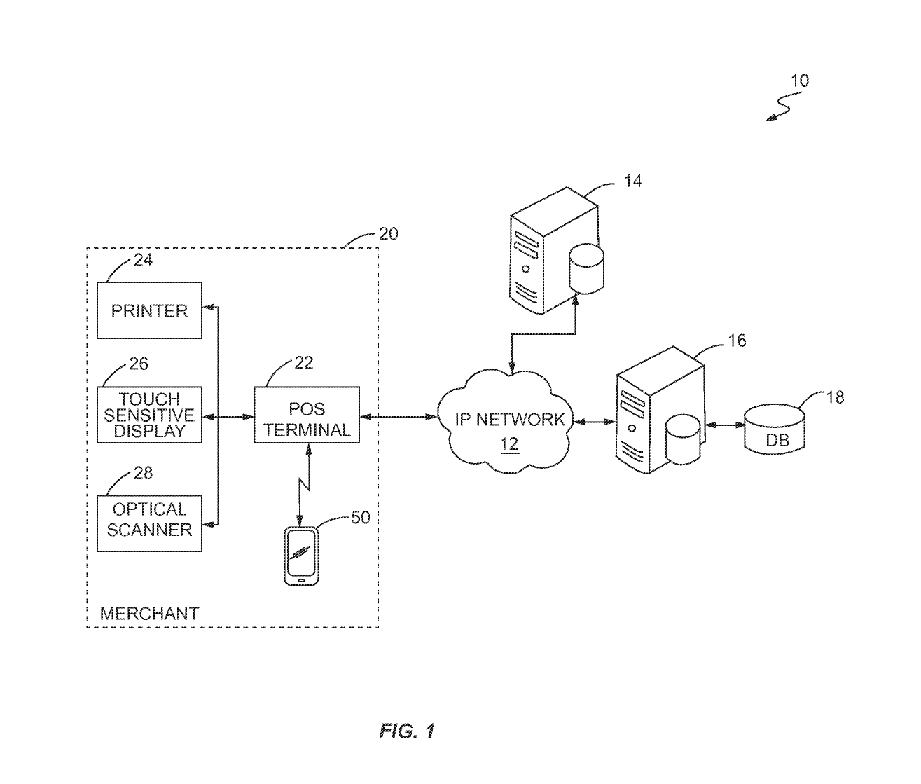

Turning now to the drawings, FIG. 1 is a functional block diagram illustrating a POS system configured according to one embodiment of the present disclosure. As seen in FIG. 1, system 10 comprises an IP network 12, an email server 14, an application server (AS) 16 connected to a database (DB) 18, and a plurality of components that are within the operational realm of a merchant site 20 (e.g., a retail establishment). Such components include, but are not limited to, a POS terminal 22, a printer device 24, a touch-sensitive display 26, and an optical scanning device 28. Additionally, as seen in FIG. 1, a customer may enter the merchant site 20 with a personal communications device 50, such as a smartphone or tablet computing device, for example. Although device 50 is not typically under the control of a merchant, embodiments of the present disclosure may be advantageously configured to utilize the functionality of device 50 when device 50 is in close proximity to the POS terminal 22, as described in more detail later.

The IP network 12 may comprise one or more public or private communication networks that communicate packets of data between the merchant site 20 and the enterprise server 16. In some embodiments, IP network 12 will also carry data packets between the merchant site 20 and the email server 14. Such IP networks 12 and the methods they use to carry packet data are well-known in the art; however, for completeness, IP network 12 may comprise the Internet and/or any other public and private networks capable of communicating data packets using the well-understood Transmission Control Part (TCP)/Internet Protocol (IP). In some embodiments, IP network 12 represents the “cloud.” In these cases, one or both of the email server 14 and the AS 16, along with DB 18, are remotely located in the “cloud.”

Email server 14 comprises any computing device known in the art that includes the hardware and software necessary for sending and receiving email messages with remote devices. In the context of the present embodiments, email server 14 is configured to receive receipt data from the POS terminal 22 in an electronic form, and generate an email message with the receipt data attached to the message. Email server 14 may then send the email along with the attached receipt data to an email account specified by the customer. Such emails may be generated and sent, for example, in lieu of printing a receipt, or in addition to printing a receipt.

AS 16 also comprises a computing device, and is configured with the requisite hardware and software needed for communicating information regarding customer transactions with POS terminal 22. By way of example only, AS server 16 may receive request messages from POS terminal 22 for data related to an item being scanned for purchase at POS terminal 22. Such data includes, but is not limited to, pricing data, inventory data, description data, and the like. Upon receipt of a request, AS 16 is configured to retrieve the data from DB 18, and return the data in a response message to POS terminal 22. Transaction details regarding the items of the transaction may then be sent back to AS 16 at the end of the transaction so that a receipt for the purchased items may be generated.

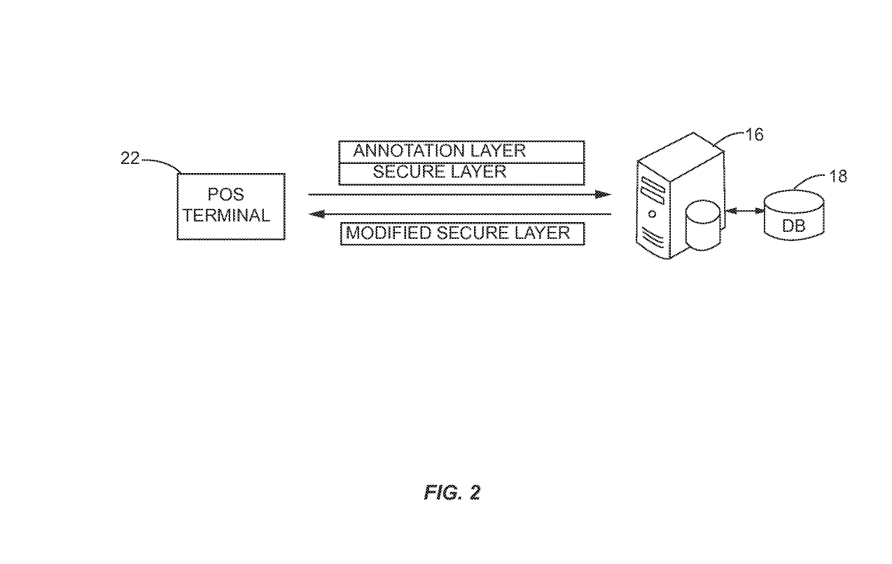

In addition to the functions above, AS 16 is also configured, in some embodiments, to modify the underlying details of the transaction in accordance with annotation data provided by one or both of the sales associate and the customer. Such modification may occur while the transaction is on-going at the POS terminal 22. For example, as seen in FIG. 2, the underlying details of the transaction (e.g., those that are obtained from an optical scan of the product code) are sent to AS 16 in a secure data layer. In addition, embodiments of the present disclosure also send annotation data provided by the sales associate and/or the customer to the AS 16 in a separate annotation layer. In embodiments where AS 16 generates a receipt, AS 16 will first alter the underlying transaction details according to the annotation data before returning the modified transaction data as the receipt to the POS terminal 22.

Returning to FIG. 1, the merchant site 20, as stated above, comprises a retail establishment that sells or rents products and/or services to customers. To that end, the merchant site 20 comprises a POS terminal 22 that enables a sales associate to effect a transaction associated with a product or service for the customer. The POS terminal 22 is a computing device that is specially configured to function according to the present disclosure, as is described in more detail below, and communicatively connects to printer device 24, a touch-sensitive display 26, and an optical scanner 28.

In operation, a sales associate or customer would utilize the optical scanner 28 to read a product code or other identifier on the packaging of a product. POS terminal 22 would then send the identifier to the AS 16 in a request message to retrieve information about the product (e.g., description, price, etc.). Once the POS terminal 22 receives the information from AS 16, POS terminal 22 sends the information to display 26 for the sales associate. Once the transaction is complete, the POS terminal 22 sends the details of the transaction to the printer 24 to print a receipt for the customer and/or the email server 14 to send the receipt to the customer's email account.

It should be understood that the embodiments of the present disclosure are not limited to operating only with a single display 26. In some embodiments, for example, the touch sensitive display 26 is a two-sided display, each side of which may be touch-sensitive. In these embodiments, the information returned from AS 16 is sent by POS terminal 22 to both sides of the display 26 such that both the sales associate and the customer are able to view the information. However, in embodiments where display 26 is a single display, the POS terminal 22 may be configured to utilize the functions of the customer's own mobile device 50. In these cases, POS terminal 22 is configured to establish a short-range communication link with customer device 50 using BLUETOOTH or any other well-known short-range communications protocol (e.g., WiFi, and the like). Once established, POS terminal 22 can communicate with device 50 via the established link, and utilize the display on device 50 to display the information returned from AS 16. It should be noted that, in these latter cases, device 50 may be equipped with an application program specifically designed communicate with the POS terminal 22 to send and receive information.

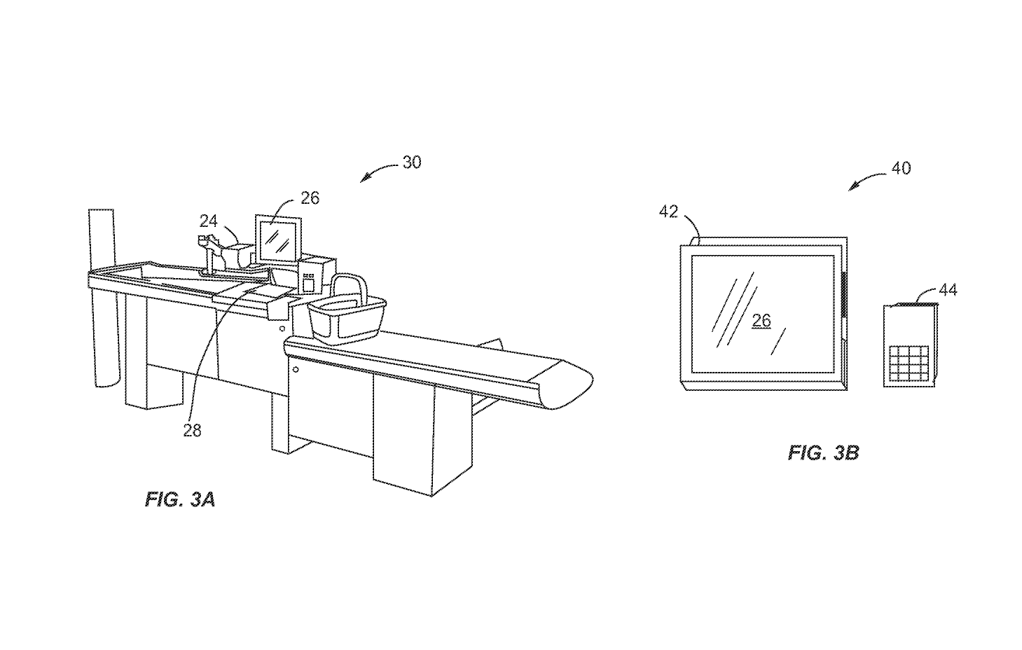

Additionally, those of ordinary skill in the art should readily appreciate that the POS terminal 22 is not limited to solely one type of POS terminal. As seen in FIG. 3A, for example, POS terminal 22 may be embodied as a fixed-position checkout station 30. Such stations may be employee-assisted type stations, or self-checkout stations. Alternatively, as seen in FIG. 3B, POS terminal may be embodied as a Mobile POS (MPOS) terminal 40. As is known in the art, MPOS terminals 40 comprise a tablet 42 and a portable payment terminal (PPT) 44 that docks with tablet 42. In mobile scenarios, the sales associate roams the aisles of merchant site 20 with MPOS terminal 40, and uses the PPT terminal 42 to scan products selected by the customer. Thus, as seen in FIGS. 3A and 3A, embodiments of the present disclosure are equally suitable for use in merchant sites 20 that utilize fixed POS terminals 22 (e.g., checkout 30), mobile POS terminals 22 (e.g., MPOS terminal 40), or a combination of such POS terminals.

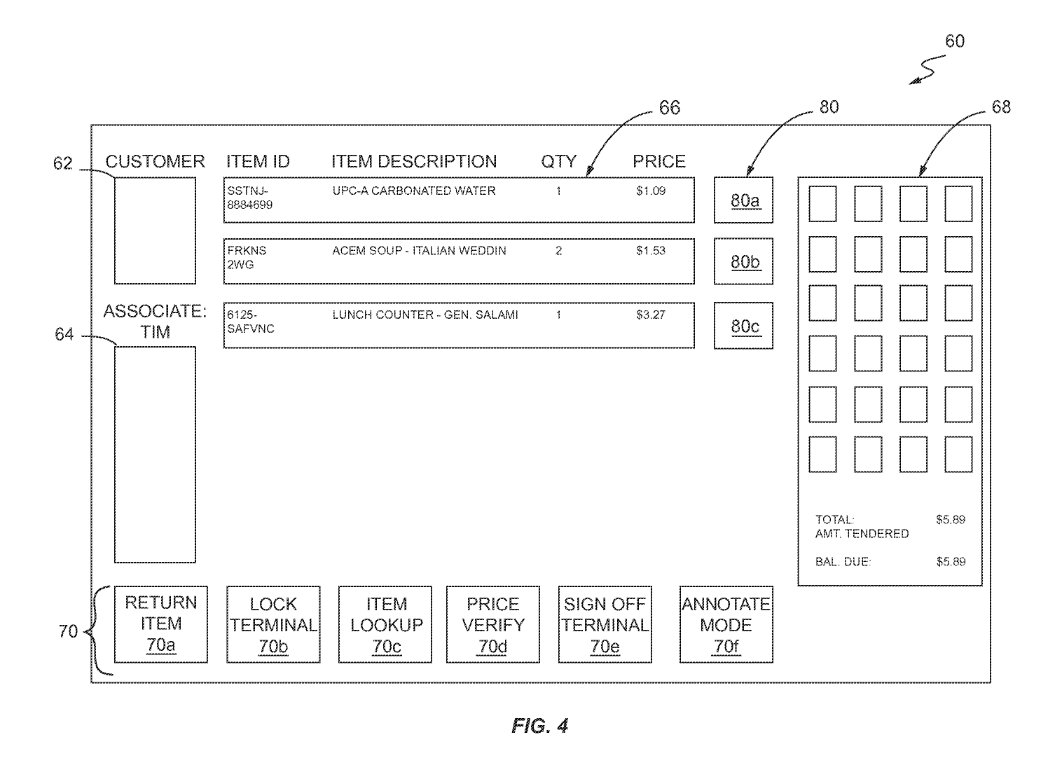

As stated above, one or both of the sales associate and a customer may provide annotation data that is utilized by the POS terminal 22 to modify the underlying details of a given customer transaction while the items associated with that transaction are being scanned (i.e., while the transaction is being performed at the POS terminal 22). This differs from conventional methods for annotating receipts, which do not modify the underlying transaction details, but instead, simply overlay annotation data onto a receipt (e.g., as an image) at the time the receipt is printed. To accomplish this function, embodiments of the present disclosure provide a specially configured Graphical User interface (GUI) 60, such as the GUI seen in FIG. 4.

As seen in FIG. 4, GUI 60 is comprised of a number of different areas that enable the sales associate and the customer to view and understand the details associated with a given transaction. It should be realized that GUI 60 may be displayed on display 26. In cases where display 26 comprises a two-sided display, GUI 60 may be displayed in whole, or in part, on both sides of display 26. In cases where POS terminal communicates with the customer's device 50, GUI 60 may be displayed in whole or in part on both display 26 for the sales associate, and on the display of device 50 for the customer.

Regardless of whether device 26 is a single-sided display or a two-sided display, or whether a separate display device is used in addition to display 26, GUI 60 comprises a customer ID section 62 that identifies a customer (e.g., via a scan of the customers loyalty card), an associate section 64 that identifies the sales associate operating POS terminal 22, a product section 66 that displays various information about a product being scanned by scanner 28, an input/output (I/O) section 68 that provides a variety of buttons and controls for the sales associate to use when performing the transaction, and a control section 70 that also provides a plurality of control buttons 70a-70f that enables the sales associate to control the operation of POS terminal 22.

In addition to the above, however, GUI 60 is also equipped with an annotation section 80 that is comprised of a plurality of independent annotation areas 80a, 80b, 80c—one area for each line in the products section 66. During normal operation, the annotation areas 80a, 80b, 80c are “greyed out” signifying that they are inactive. In this state, neither the sales associate nor the customer can enter annotation data into GUI 60. However, as described in more detail later, one or both of the sales associate and the customer can enter a command or perform some other action to place the POS terminal 22 in the annotation mode. For example, the sales associate or the customer may touch the “ANNOTATE MODE” control 70f to place POS terminal i22 into the annotation mode. In this mode, the annotation areas 80a, 80b, 80c are activated to allow the sales associate and/or the customer (i.e., whoever placed the POS terminal in the annotation mode) to enter annotation information. The POS terminal 22 is configured, according to one embodiment, to modify the underlying transaction details with the annotation information, and to generate a receipt for the transaction that includes these modified transaction details.

The annotation data may comprise free form text that is entered by the sales associate or the customer into one or more of the annotation areas 80a, 80b, 80c of GUI 60. By way of example, consider a customer who purchases eight of the same items. Conventionally, a sales associate may scan each of the eight items separately. Alternatively, the sales associate may scan one of the items, and then utilize a keypad or other device to enter a code to indicate the additional items. The sales associate would then key in the number ‘8’ to identify that the POS terminal 22 should count all eight items.

Such methods, however, are cumbersome and time consuming for the sales associate. Therefore, in accordance with the present disclosure, the sales associate could simply place the POS terminal 22 into the annotation mode by touching control button 70f of GUI 60. Once POS terminal 22 is in the annotation mode, the annotation areas 80a, 80b, 80c are enabled. The sales associate could then, in the annotation area 80a, 80b, 80c next to the scanned item of interest, “write” a command such as “QU” for “Quantity Update” and the number ‘8’ with a finger or stylus, for example. The result would be for the POS terminal 22 to modify the underlying transaction details to reflect that 8 of the item are being purchased instead of just 1.

In another example, consider a customer who is purchasing a number of items for different people, each of which will pay the customer the cost of the purchase. In these scenarios, the sales associate would scan the different items, as is conventional. However, while the sales associate is performing the scans, the user could interact with the GUI 60 to place the POS terminal 22 into the annotation mode, as previously described. Then, while the sales associate continues to scan successive items, the customer could enter free-form text in each of the annotation areas 80a, 80b, 80c to match the scanned items to a specific person. For example, the customer may “write” a person's initials, name, or other unique identifier into the annotation areas 80a, 80b, 80c to accurately match the scanned item to the person. The result would be transaction details that are amended to include, for one or more of the items, the customer-provided identifiers indicating the people for whom the customer purchased the items.

Regardless of the reason for activating the annotation mode, the POS terminal 22 is configured to analyze the free-form text entered into the annotation section 80 using, for example, any of a number of well-known optical recognition algorithms. Then, POS terminal 22 is configured to generate a receipt for the customer that reflects both the details obtained by scanning the item, as well as the annotation details that are provided by the sales associate and/or the customer. However, rather than simply overlaying the annotation data on top of a printed receipt, as is convention, a POS terminal 22 configured according to the present embodiments modifies the underlying details of the transaction, and then generates the receipt utilizing the modified transaction details.

Those of ordinary skill in the art will realize that the entry of free-form text into the annotation section 80 using a finger or stylus is not the only method by which annotation data can be provided to POS terminal 22. In another embodiment, for example, the sales associate and/or the customer may utilize a microphone associated with the POS terminal 22 (and/or the customer's mobile device 50 when that device is employed) and speak the annotation data. In these cases, voice recognition software, which is well-known in the art, could be utilized to analyze the spoken words, translate those words into annotation data, and then display the translated annotation data in the annotation section 80 as previously described.

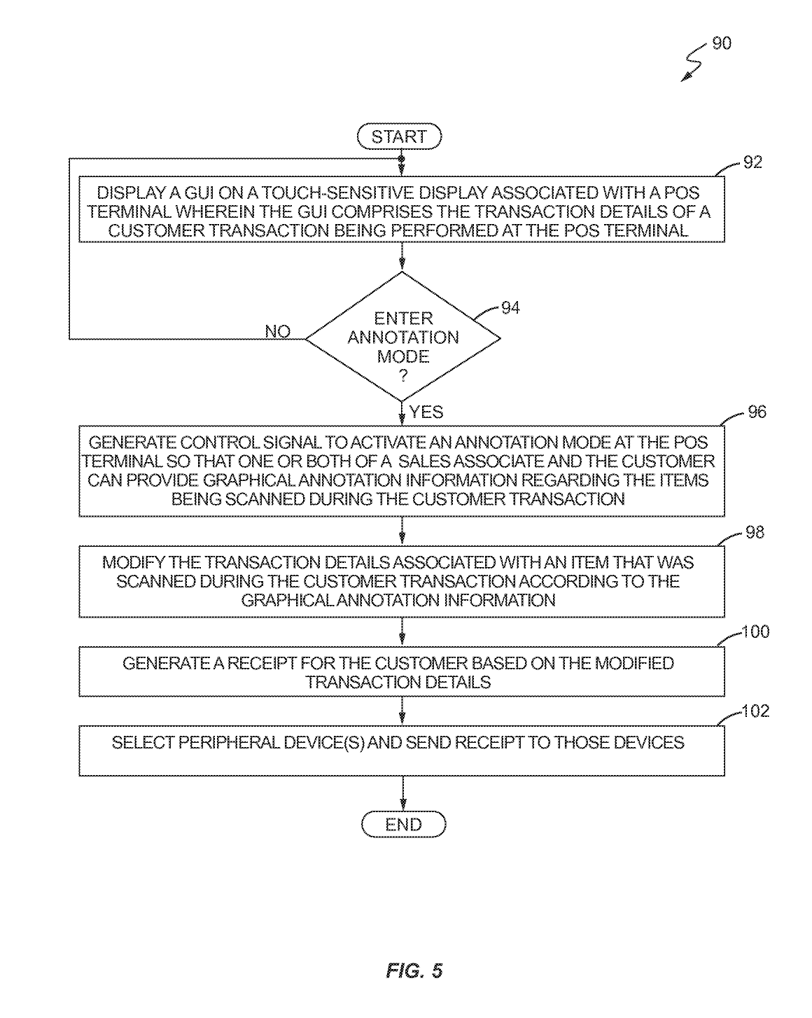

FIG. 5 is a flow diagram illustrating a method 90 for generating a receipt at POS terminal 22 according to one embodiment of the present disclosure. Method 90 begins with the POS terminal 22 displaying GUI 60 on touch-sensitive display 26 while a customer transaction is being performed at POS terminal 22 (box 92). GUI 60 would comprise, as previously described, the details of the customer transaction (e.g., sections 62, 64, 66, 68). While the sales associate continues to scan a customer's selected items, POS terminal 22 will detect if the POS terminal 22 is placed into the annotation mode (box 94). Such detection, for example, my comprise POS terminal 22 detecting that a control button 70f has been touched by a user. Upon detecting the user touch, POS terminal 22 generates a control signal to activate the annotation mode (box 96). In this mode, one or both of the sales associate and the customer can provide the annotation data (e.g., via free-form text, voice commands, etc.), which is then displayed on the GUI 60 in the appropriate annotation area 80a, 80b, 80c. Once entered, POS terminal 22 modifies the underlying details of the transaction in accordance with the annotation data (box 98) and generates a receipt for the user based on those modified transaction details (box 100). The POS terminal 22 may then send the generated receipt, which includes the annotation data, to printer 24 for printing a paper receipt, and/or to email server 14 to be emailed as an attachment to the customer (box 102).

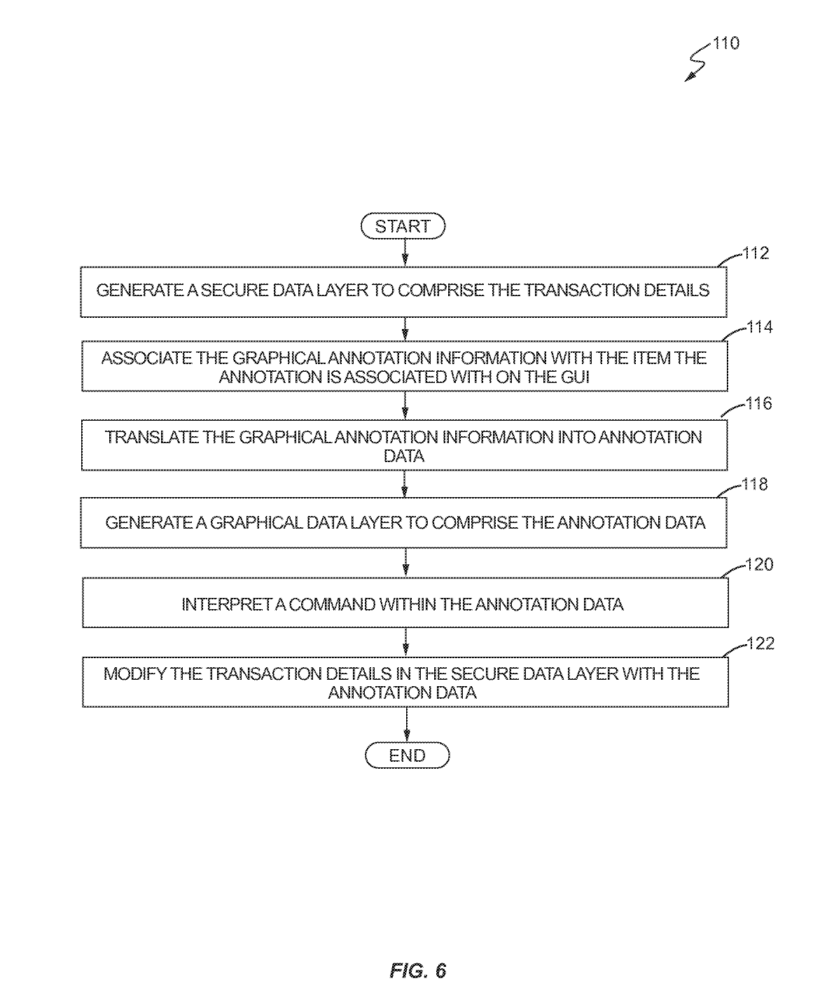

There are various ways in which POS terminal 22 can modify the underling transaction details. For example, as seen in FIG. 6, the POS terminal may be configured to perform the modification locally at the POS terminal 22. More particularly, method 110 begins with the POS terminal 22 generating a secure data layer to contain the transaction details (box 112). As stated above, such details include, but are not limited to, the information about a given item that has been scanned (e.g., product ID, description, price, etc.). Normally, these details are communicated with the AS 16. POS terminal 22 then associates the annotation data entered into the annotation section 80 with the items displayed on the GUI 60 (box 114). By way of example, each line item in section 64 may have an ID that can be matched to the ID of an annotation area 80a, 80b, 80c. So matched, the POS terminal 22 can maintain a mapping between the line items in section 64 and the annotation areas 80a, 80b, 80c in annotation section 80.

POS terminal 22 is then configured to translate the annotation data in each of the annotation areas 80a, 80b, 80c to a form that is understood by the POS terminal 22 (box 116), and generate a separate annotation data layer to comprise the translated annotation data (box 118). For example, as previously stated, POS terminal 22 may employ any well-known optical or voice recognition algorithm to translate the annotation data.

In some embodiments of the present disclosure, the annotation data may include a command as well as annotation information. Such commands may be used, for example, control how the POS terminal 22 modifies the underlying transaction details. By way of example only, a first command “QU” may indicate that the POS terminal 22 should update the quantity of a particular item. The annotation information that is associated with the command would then indicate how much the quantity should be updated. For example, a sales associate or customer may enter an annotation using free-form text as “QU 8” next to a selected line item in section 66. The POS terminal 22, as described previously, would then translate the annotation data to identify the command “QU” and the integer “8.” Once identified, POS terminal 22 would interpret the command (box 120) as “perform a quantity update,” identify which item in section 66 is to be modified, and then modify the underlying details for that item in the secure data layer to reflect a quantity of 8 (box 122). In this manner, embodiments of the present disclosure alter the underlying details that comprise the transaction rather than simply overlaying the annotation data as an image, for example, on top of those details, as is conventional.

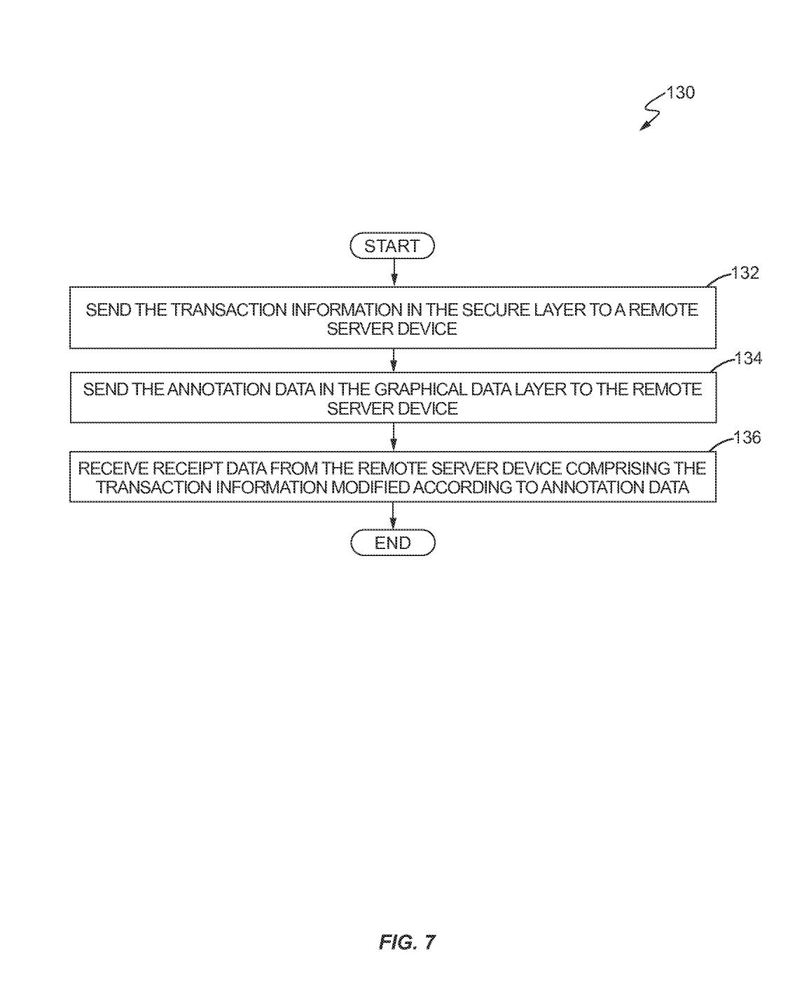

It should be noted, however, that the present disclosure is not limited to embodiments in which the POS terminal 22 performs the translation. As seen in FIG. 7, for example, another embodiment of the present disclosure advantageously utilizes the processing power provided by other devices, such as AS 16. This particular embodiment is useful, for example, in scenarios where the POS terminal 22 does not have the processing resources that are necessary for analyzing and translating the annotation data.

Method 130 assumes that the sales associate and/or the customer have already scanned items and provided annotation data. However, like the previous embodiment, POS terminal still generates a secure data layer to contain the underlying transaction details, and a separate annotation layer to contain the annotation data.

To that end, method 130 begins with POS terminal 22 sending the transaction information in the secure data layer to a remote server, such as AS 16, via network 12 (box 132). POS terminal 22 then sends the annotation data in the annotation data layer to the remote server (box 134). The transaction information in the secure data layer and the annotation data in the annotation data layer, while being separate layers, may or may not be sent in a same message to the remote server. Upon receipt, the server would interpret the commands in the annotation data, and modify the underlying transaction information in the secure data layer in accordance with those commands. This process would result in the generation of receipt data that comprises the modified transaction information in the secure data layer. The receipt data is then returned to POS terminal 22. Upon receipt (box 136), POS terminal 22 could send the receipt data to the printer 24 and/or the email server 14, as previously described.

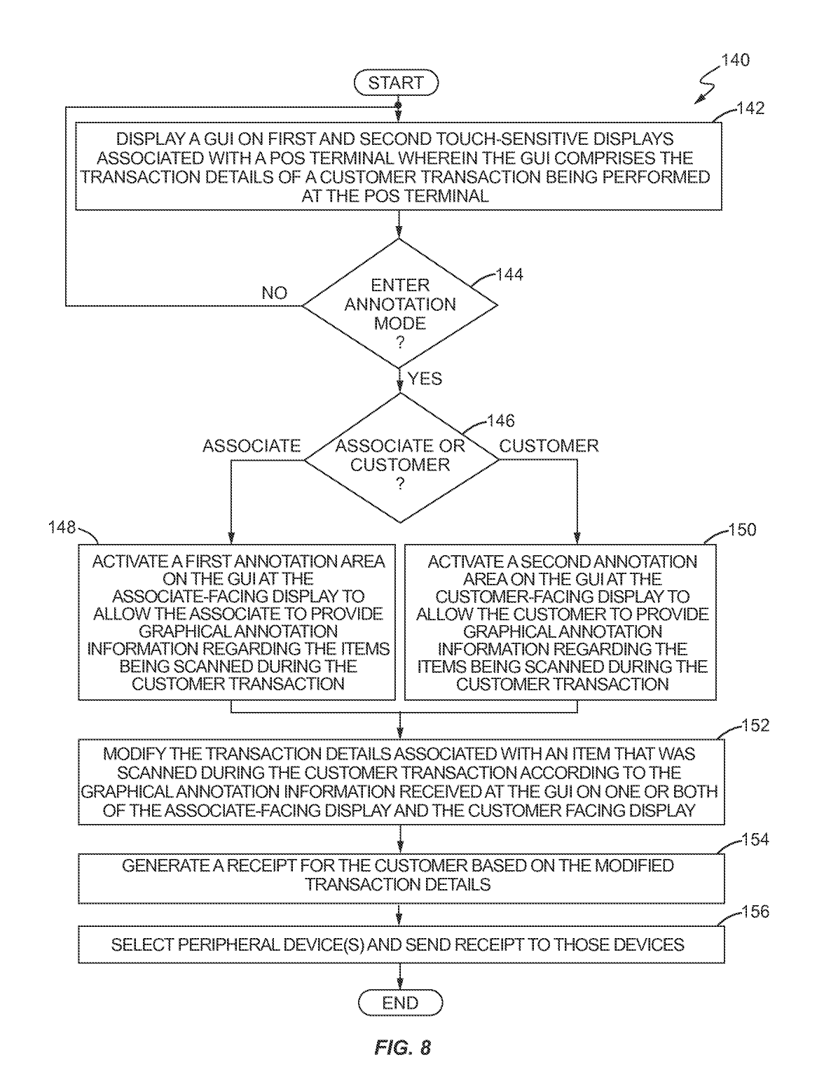

FIG. 8 is a flow diagram illustrating another embodiment of the present disclosure in which the POS terminal 22 utilizes two displays. For example, the touch-sensitive display 26 may be a two-sided display with one side of the display facing the sales associate and the other side of the display facing the customer. Alternatively, one of the displays may be the touch-sensitive display 26 facing the sales associate, while the other comprises the display on the customer's own mobile device 50. Regardless, embodiments of the present disclosure display GUI 60 on each display, and are configured to receive annotations from or both of the sales associate and the customer via the GUI 60 displayed on their respective displays.

Method 140 begins with POS terminal 22 displaying the GUI 60 on both a first display and a second display. The GUIs 60 on both displays indicate the underlying details of a customer transaction being performed at the POS terminal 22 (box 142). Further, both displays in this embodiment are touch-sensitive. As above, POS terminal 22 continues to perform its scanning functions associated with the customer transaction, but also detects when one or both of the sales associate and the customer places the POS terminal in the annotation mode (box 144). Upon detecting that the POS terminal 22 should be in the annotation mode, POS terminal 22 determines whether the sales associate or the customer placed the POS terminal 22 in the annotation mode (box 146). If the sales associate placed POS terminal 22 in the annotation mode, POS terminal 22 will activate a first annotation area of GUI 60 on the associate-facing display to allow the sales associate to enter annotation data (box 148). If the customer placed POS terminal 22 in the annotation mode, POS terminal 22 will activate a second annotation area of GUI 60 on the customer-facing display to allow the customer to enter annotation data (box 150). Of course, activating the annotation areas on different displays is not exclusive with the embodiments of the present disclosure. Rather, a POS terminal 22 configured according to the present disclosure may activate the first and second annotation areas such that these areas may be active at the same time.

Regardless, POS terminal 22 modifies the underlying transaction details in the secure data layer according to the annotation data provided by one or both of the sales associate and the customer (box 152). Such modification may be performed, for example, as previously described. POS terminal 22 then generates a receipt for the customer transaction based on the modified transaction details (box 154), and sends that receipt to a selected peripheral device, as previously described (box 156). Such peripheral devices may include, but are not limited to, printer 24 that outputs a printed receipt for the customer and/or email server 14 that generates and sends an email including the receipt to the customer.

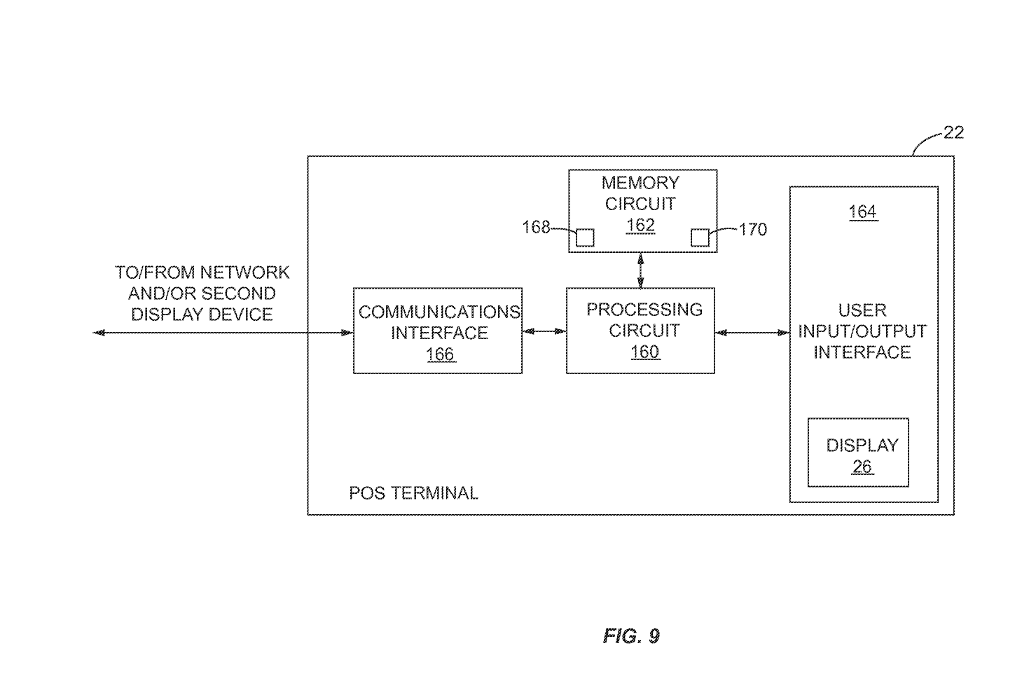

FIG. 9 is a functional block diagram illustrating some functional components of a POS terminal 22 configured according to one embodiment of the present disclosure. As seen in FIG. 8, a POS terminal 22 configured according to the present disclosure comprises a processing circuit 160, a memory circuit 162, a user I/O interface 164, and a communications interface 166. Those of ordinary skill in the art will readily appreciate that a POS terminal 22 configured according to the embodiments of the present disclosure may also include other functional components that are not particularly seen here.

The processing circuit 160 may comprise any sequential state machine capable of executing machine instructions stored as a machine-readable computer program 168 in the memory circuit 162, such as one or more hardware-implemented state machines (e.g., in discrete logic, FPGA, ASIC, etc.), programmable logic together with appropriate firmware, one or more stored-program, general-purpose processors, such as a microprocessor or Digital Signal Processor (DSP), together with appropriate software, or any combination of the above.

According to embodiments of the present disclosure, the processing circuit 160 is communicatively coupled to memory circuit 162 via one or more buses. The memory circuit 162 may comprise any non-transitory machine-readable storage media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, solid state disc, etc.), or the like.

The user I/O interface 164 is configured to accept input data and commands from a user associated with the POS terminal 22, such as the sales associate and/or the customer. For example, user I/O interface 164 may comprise one or more of a pointing device (such as a mouse, stylus, touchpad, trackball, pointing stick, joystick), a microphone for speech input, an optical sensor for optical recognition of gestures, a keypad or keyboard, and the like. As seen in FIG. 9, the user I/O interface 164 also comprises touch-sensitive display 26, which may or may not be a two-sided display, as previously described.

The touch-sensitive display 26 is configured to present visual information such as GUI 60 to one or both of a sales associate and a customer. Such displays are generally include circuitry that is comprised within one or more of a graphics adapter, a graphical processing unit, a display port, a Liquid Crystal display, and a Light Emitting Diode display.

The communications interface 166 comprises the hardware and software required for communicating data and information and data via network 12 with AS 16 and email server 14 according to any well-known protocol, such as the TCP/IP. Thus, communications interface 160 may comprise, for example, an Ethernet interface. Additionally, communications interface 166 is configured to communicate data and information with each of the printer 24, display 26, and optical scanner 28. Communications with these components may be performed in accordance with a well-known short-range communications protocol (e.g., via BLUETOOTH, WiFi), but may also be performed using TCP/IP via network 12. Other communications protocols known in the art or that may be developed are also possible for use with communications interface 160, such as HTTP, RTP, RTCP, HTTPs, ATM, or the like.

In embodiments where POS terminal 22 communicates with a customer's mobile device 50, communications interface 166 may also implement wireless receiver and transmitter functionality appropriate to a communication network to which it is attached (e.g., Wi-Fi) and appropriate for sending and receiving signals to and from mobile device 50 (e.g., NFC, BLUETOOTH, RFID). The transmitter and receiver functionality may share circuit components and/or software, or alternatively may be implemented separately within the communications interface 166.

In operation, processing circuitry 160 is configured, via the communications interface 166, to communicate data associated with customer transactions with a remote device, such as AS 16, over IP network 12. The processing circuit 160 is further configured to display GUI 60 on touch-sensitive display 26. As previously stated, GUI 60 comprises transaction information associated with a customer transaction being performed at the POS terminal 22. The processing circuit 160 is also configured to activate an annotation mode of the POS terminal 22 while the customer transaction is being performed. Activation may be performed, for example, responsive to receiving user input at display 26. In the annotation mode, GUI 60 is configured to receive graphical input from one or both of the sales associate and the customer. The processing circuit 160 is further configured to modify the transaction information according to the provided annotation(s), and generate a receipt for the customer transaction based on the modified transaction information.

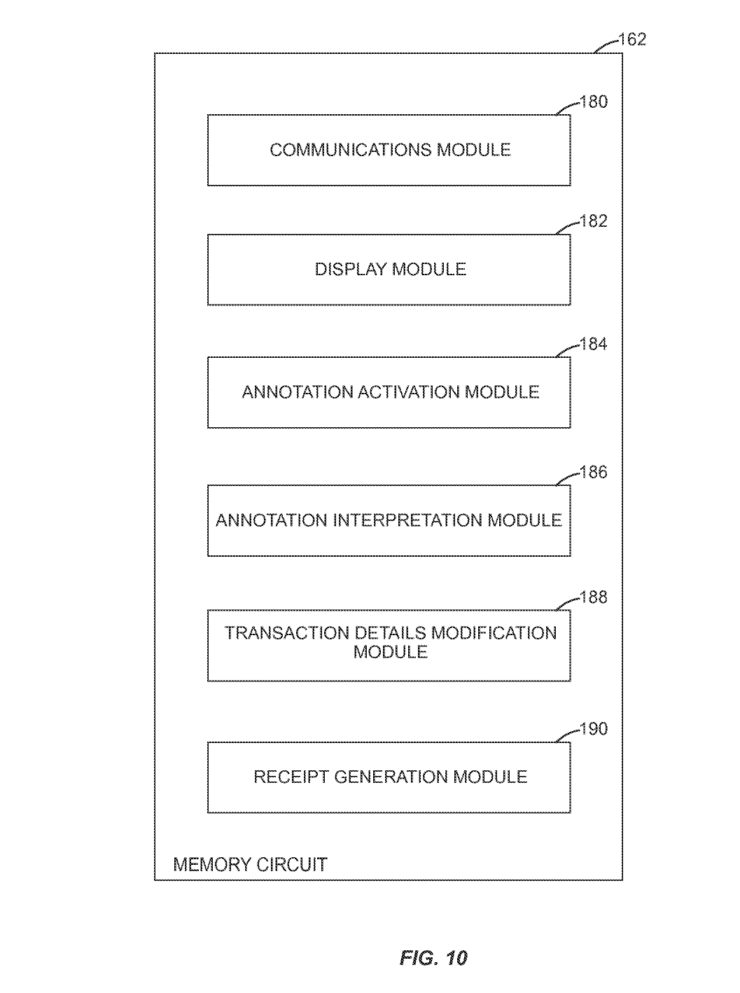

FIG. 10 illustrates memory circuit 162 comprising software modules for performing embodiments as discussed above. The memory circuit 162 comprises a communications module 180, a display module 182, an annotation activation module 184, and annotation interpretation module 186, a transaction details modification module 188, and a receipt generation module 190.

The communications module 180 is configured to communicate data associated with customer transactions with a remote device, such as AS 16, over communications network 12. Additionally, communications module 180 may also communicate with email server 14 via network 12, as well as with printer 24, display 26, and scanner 28. The display module 182 is configured to display GUI 60 on touch-sensitive display 26 to display transaction information associated with a customer transaction being performed at the POS terminal 22 to one or both of the sales associate and the customer. The annotation activation module 184 is configured to activate an annotation mode of the POS terminal 22 while the customer transaction is being performed responsive to receiving user input. In the annotation mode, the GUI is configured to receive annotation data from one or both of an operator of the POS terminal and a customer. The annotation interpretation module 186 is configured to interpret the annotations entered by one or both of the sales associate and the customer to determine one or more commands in the annotation data. The transaction details modification module 188 is configured to modify the underlying transaction information associated with the customer transaction according to the one or more commands and annotation data. The receipt generation module 190 is configured to generate a receipt for the customer transaction based on the modified transaction information.

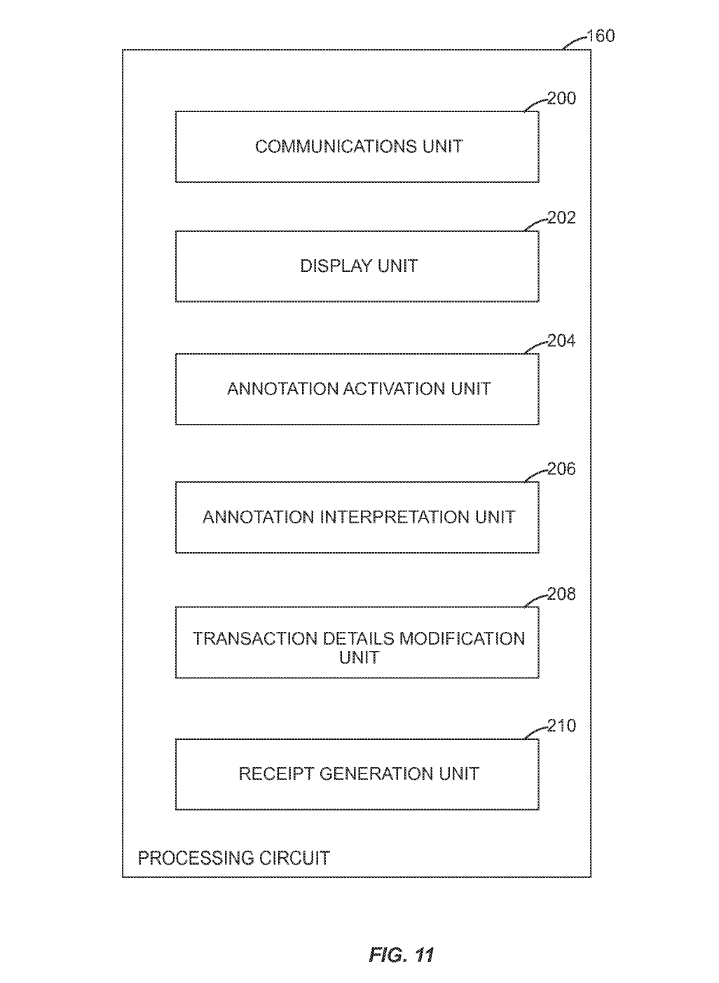

FIG. 11 illustrates an embodiment of the processing circuit 160 comprising physical hardware units. The processing circuit 160 comprises a communications unit 200, a display unit 202, an annotation activation unit 204, an annotation interpretation unit 206, a transaction details modification unit 208, and a receipt generation unit 210.

The communications unit 200 is configured to communicate data associated with customer transactions with a remote device, such as AS 16, over IP network 12. Additionally, communications unit 200 may communicate with email server 14 via network 12, as well as with printer 24, display 26, and scanner 28. The display unit 202 is configured to display GUI 60 on touch-sensitive display 26. GUI 60 displays transaction information associated with a customer transaction being performed at the POS terminal 22 to one or both of the sales associate and the customer. The annotation activation unit 204 is configured to activate an annotation mode of the POS terminal 22 while the customer transaction is being performed responsive to receiving user input. In the annotation mode, the GUI 60 is configured to receive annotation data from one or both of an operator of the POS terminal 22 and a customer. The annotation interpretation unit 206 is configured to interpret the annotation data entered by one or both of the sales associate and the customer to determine one or more commands in the annotation data. The transaction details modification unit 208 is configured to modify the underlying transaction information associated with the customer transaction according to the one or more commands and annotations. The receipt generation unit 210 is configured to generate a receipt for the customer transaction based on the modified transaction information.

Those skilled in the art will appreciate that the various methods and processes described herein may be implemented using various hardware configurations that generally, but not necessarily, include the use of one or more microprocessors, microcontrollers, digital signal processors, or the like, coupled to, or comprising, memory storing software instructions or data for carrying out the techniques described herein.

The present invention may, of course, be carried out in other ways than those specifically set forth herein without departing from essential characteristics of the invention. Therefore, the present embodiments are to be considered in all respects as illustrative and not restrictive, and all changes coming within the meaning and equivalency range of the appended claims are intended to be embraced therein.

What is claimed is:

1. A computer-implemented method comprising:
displaying a Graphical User Interface (GUI) on a display operatively connected to a Point-of-Sale (POS) terminal, wherein the GUI displays transaction information associated with a customer transaction being performed at the POS terminal;
activating an annotation mode of the POS terminal while the customer transaction is being performed responsive to receiving user input, wherein in the annotation mode, the GUI is configured to receive annotation data from one or both of an operator of the POS terminal and a customer;
modifying the transaction information according to the annotation data; and
generating a receipt for the customer transaction based on the modified transaction information.

2. The computer-implemented method of claim 1 wherein displaying a GUI on a display associated with a POS terminal comprises displaying the GUI on a first display that faces the operator of the POS terminal, and on a second display that faces the customer.

3. The computer-implemented method of claim 2 wherein activating an annotation mode of the POS terminal while the customer transaction is being performed comprises:
activating a first annotation area of the GUI on the first display responsive to receiving user input from the operator, wherein the first annotation area is configured to receive the annotation data from the operator; and
activating a second annotation area of the GUI on the second display responsive to receiving user input from the customer, wherein the second annotation area is configured to receive the annotation data from the customer.

4. The computer-implemented method of claim 3 wherein modifying the transaction information according to the annotation data comprises modifying the transaction information to include the annotation data received at each of the first and second annotation areas.

5. The computer-implemented method of claim 1 wherein activating an annotation mode of the POS terminal while the customer transaction is being performed comprises controlling the POS terminal to enter the annotation mode while items associated with the customer transaction are being scanned.

6. The computer-implemented method of claim 1 wherein modifying the transaction information according to the annotation data comprises:
generating a secure data layer to comprise the transaction information associated with the customer transaction being performed at the POS terminal;
translating the annotation data to identify annotation information and a command;
generating a annotation data layer to comprise the annotation information; and
modifying the transaction information in the secure data layer with the annotation information in the annotation data layer according to the annotation command.

7. The computer-implemented method of claim 6 wherein modifying the transaction information in the secure data layer with the annotation information in the annotation data layer comprises:
interpreting the command provided in the annotation data; and
executing a modification function to modify the transaction information in the secure data layer with the annotation information based on the command.

8. The computer-implemented method of claim 6 wherein modifying the transaction information in the secure data layer with the annotation information in the annotation data layer comprises:
sending the transaction information in the secure data layer to a remote device over a communications network;
sending the annotation data in the annotation data layer to the remote device over the communications network; and
receiving receipt data comprising the modified transaction information in the secure data layer from the remote device via the communications network.

9. The computer-implemented method of claim 1 wherein generating a receipt for the customer transaction based on the modified transaction information comprises sending the modified transaction information to one or both of a printing device and an email server.

10. The computer-implemented method of claim 1 wherein the graphical input comprises free-form text.

11. A Point-of-Sale (POS) terminal comprising:
a communication interface circuit configured to communicate data associated with customer transactions with a remote device over a communications network;
a processing circuit configured to:
display a Graphical User Interface (GUI) on a display, wherein the GUI displays transaction information associated with a customer transaction being performed at the POS terminal;
activate an annotation mode of the POS terminal while the customer transaction is being performed responsive to receiving user input, wherein in the annotation mode, the GUI is configured to receive annotation data from one or both of an operator of the POS terminal and a customer;
modify the transaction information according to the annotation data; and
generate a receipt for the customer transaction based on the modified transaction information.

12. The POS terminal of claim 11 wherein the processing circuit is configured to display the GUI on a first touch-sensitive display that faces the operator of the POS terminal, and on a second touch-sensitive display that faces the customer.

13. The POS terminal of claim 12 wherein to activate the annotation mode of the POS terminal while the customer transaction is being performed, the processing circuit is configured to:
activate a first annotation area of the GUI on the first display responsive to receiving input from the operator, wherein the first annotation area is configured to receive the annotation data from the operator; and
activate a second annotation area of the GUI on the second display responsive to receiving input from the customer, wherein the second annotation area is configured to receive the annotation data from the customer.

14. The POS terminal of claim 13 wherein the processing circuit is configured to modify the transaction information to include the annotation data received at each of the first and second annotation areas.

15. The POS terminal of claim 11 wherein the processing circuit is configured to control the POS terminal to enter the annotation mode while items associated with the customer transaction are being scanned.

16. The POS terminal of claim 11 wherein the processing circuit is configured to:
generate a secure data layer to comprise the transaction information associated with the customer transaction being performed at the POS terminal;
translate the annotation data to identify annotation information and a command;
generate a graphical data layer to comprise the annotation information; and
modify the transaction information in the secure data layer with the annotation information in the annotation data layer according to the annotation command.

17. The POS terminal of claim 16 wherein to modify the transaction information in the secure data layer with the annotation information in the annotation data layer, the processing circuit is configured to:
interpret the command in the annotation data; and
modify the transaction information in the secure data layer with the annotation information based on the command.

18. The POS terminal of claim 16 wherein to modify the transaction information in the secure data layer with the annotation information in the annotation data layer, the processing circuit is configured to:
send the transaction information in the secure data layer to a remote device over a communications network;
send the annotation data in the annotation data layer to the remote device over the communications network; and
receive receipt data comprising the modified transaction information in the secure data layer from the remote device via the communications network.

19. The POS terminal of claim 11 wherein the processing circuit is configured to send the modified transaction information to a selected peripheral device, wherein the selected peripheral device comprises one or both of a printing device and an email server.

20. A computer-readable storage medium comprising computer program code stored thereon that, when executed by a processing circuit of a Point-of-Sale (POS) terminal, configures the POS terminal to:
communicate data with a remote device over a communications network;
display a Graphical User Interface (GUI) on a display, wherein the GUI displays transaction information associated with a customer transaction being performed at the POS terminal;
activate an annotation mode of the POS terminal while the customer transaction is being performed responsive to receiving user input, wherein in the annotation mode, the GUI is configured to receive annotation data from one or both of an operator of the POS terminal and a customer;
modify the transaction information according to the annotation data; and
generate a receipt for the customer transaction based on the modified transaction information.
